(19) United States
(12) Patent Application Publication
(10) Pub. No.: US 2013/0270251 A1
(43) Pub. Date: Oct. 17, 2013

(54) LIGHTED SIGNALS TO PROVIDE DIRECTION TO USER

(71) Applicant: WHIRLPOOL CORPORATION, Benton Harbor, MI (US)

(72) Inventors: LUCIANO L. FURUTI, Joinville (BR); OCTAVIO GONZALEZ, Celaya (MX); CARLOS E. IURK, Joinville (BR); YEN-HSI LIN, St. Joseph, MI (US); MANUEL MATA, Celaya (MX); RAFEAL CAMPOS DO PRADO, St. Joseph, MI (US); JEAN RICARDO RUSCZAK, Joinville (BR); BASAVRAJ ISHWAR SANKHGOND, Pune (IN); MICHAEL T. SEUM, Chicago, IL (US); ARTHUR P. SILVA, Joinville (BR)

(73) Assignee: WHIRLPOOL CORPORATION, Benton Harbor, MI (US)

(21) Appl. No.: 13/748,635

(22) Filed: Jan. 24, 2013

Related U.S. Application Data
(60) Provisional application No. 61/624,774, filed on Apr. 16, 2012.

(51) Int. Cl. F24C 7/08; H05B 3/68

(52) U.S. Cl. CPC F24C 7/083; H05B 3/68
USPC 219/445.1; 219/447.1

(57) ABSTRACT

A cooktop, having at least one burner and at least one control. Each burner may be associated with a particular control. A burner sensor detects the presence of a pot on the burner. When a pot is detected, an illuminated path is activated between the burner and its associated control. A control sensor detects a user's proximity to the control. When a user is detected, the illuminated path is also activated. Alternatively, a lighting effect is used to highlight the associated burner and control. Alternatively, each burner is associated with a burner selector button or burner user selection interface, and a controller is used to adjust the parameters of a burner selected using the burner selector button. A communication link may be provided between the cooktop and a hood, and a display provided on the hood to indicate burner status, as well as other settings such as timer progress.

### CROSS REFERENCE TO RELATED APPLICATION

This application claims priority under 35 U.S.C. §119(e) to U.S. Provisional Patent Application No. 61/624,774, filed Apr. 16, 2012, entitled “LIGHTED SIGNALS TO PROVIDE DIRECTION TO USER,” which is hereby incorporated by reference in its entirety.

### FIELD OF THE INVENTION

The invention is in the field of lighted signals to provide user information and feedback relating to the operation and use of a cooktop.

### BRIEF SUMMARY OF THE INVENTION

In a first aspect, a cooktop includes a cooktop surface with at least one burner located thereon and at least one control knob, with each control knob associated with a particular burner. A burner sensor is provided to detect the presence of a pot on the at least one burner, and when a pot is detected, an illuminated path is activated leading from the relevant burner to an associated control knob of the relevant burner. A control knob sensor is also provided to detect the proximity or contact of a user with the at least one control knob. When a user is detected in proximity to the control knob, the illuminated path may also be activated, connecting the relevant control knob and an associated burner.

In another aspect, a cooktop includes a cooktop surface with at least one burner located thereon and at least one control knob, with each control knob associated with a particular burner. The cooktop further includes a control knob heat intensity signal located on or around each of the at least one control knob, or both. The heat intensity signals include a lighting signal, which is adjusted in intensity (brightness/lumens), or in number of light signals to indicate in a corresponding manner the intensity of the heat setting for the relevant burner to the user.

In a further aspect, a cooktop includes a cooktop surface with at least one burner located thereon and a hood having a hood display. A burner sensor is provided to detect the presence of a pot on the at least one burner. The cooktop is in connection with the hood, and provides information regarding burner status to the hood.

These and other features, advantages, and objects of the present invention will be further understood and appreciated by those skilled in the art by reference to the following specification, claims, and appended drawings.

### BRIEF DESCRIPTION OF THE DRAWINGS

In the drawings:

FIG. 1 is a front elevational view of a kitchen environment having a cooktop and a hood;

FIG. 2 is a top perspective view of one embodiment of the cooktop;

FIG. 3A is a top plan view of the cooktop of FIG. 2;

FIG. 3B is a top plan view of the cooktop of FIG. 2 with a pan placed on the burner;

FIG. 3C is a top plan view of the cooktop of FIG. 2 showing an illuminated path from the burner to the knob;

FIG. 4 is a top perspective view of the cooktop of FIG. 2 showing an illuminated path from the burner to the knob;

FIG. 5A is a top plan view of the cooktop of FIG. 2;

FIG. 5B is a top plan view of the cooktop of FIG. 2 with a hand of a user approaching the knob;

FIG. 5C is a top plan view of the cooktop of FIG. 2 with a hand of a user touching the knob;

FIG. 6 is a top perspective view of another embodiment of a cooktop;

FIG. 7A is a top plan view of the cooktop of FIG. 6;

FIG. 7B is a top plan view of the cooktop of FIG. 6 with a pan placed on the burner;

FIG. 7C is a top plan view of the cooktop of FIG. 6 showing an illuminated burner and an illuminated control knob;

FIG. 8 is a top perspective view of the cooktop of FIG. 6 with a pan on the burner;

FIG. 9A is a top plan view of the cooktop of FIG. 6 with a hand of a user touching the knob;

FIG. 9B is a top plan view of the cooktop of FIG. 6 when set on a low heat setting;

FIG. 9C is a top plan view of the cooktop of FIG. 6 when set at a high heat setting;

FIG. 10 is a top perspective view of another embodiment of a cooktop and hood;

FIG. 11 is a top perspective view of a cooktop and hood of FIG. 10 showing burner mapping on the display;

FIG. 12A is a top plan view of the cooktop of FIG. 10;

FIG. 12AA is a front elevational view of the hood of FIG. 10 showing the timer set;

FIG. 12B is a top plan view of the cooktop and a front elevational view of the hood of FIG. 10 showing the timer counting down;

FIG. 12C is a top plan view of the cooktop and a front elevational view of the hood of FIG. 10 showing the timer further counting down;

FIG. 12D is a top plan view of the cooktop and a front elevational view of the hood of FIG. 10 showing the timer further counting down;

FIG. 12E is a top plan view of the cooktop and a front elevational view of the hood of FIG. 10 with the timer expired;

FIG. 13 is a cross-sectional view of one embodiment of a lighted knob;

FIG. 14 is an exploded top perspective view of the lighted knob of FIG. 13;

FIG. 15 is a cross-sectional view of another embodiment of a lighted knob;

FIG. 16 is a top perspective view of a light guide for use in the lighted knob of FIG. 15;

FIG. 17 is a cross-sectional view of the light guide shown in FIG. 16;

FIG. 18 is a cross-sectional view of another embodiment of a light guide for use in the lighted knob shown in FIG. 15;

FIG. 19 is a top perspective view of a printed circuit board for use with the light guide of FIG. 18;

FIG. 20 is a cross-sectional view of yet another embodiment of a lighted knob; and

FIG. 21 is a top perspective cross-sectional view of a light guide for use in the lighted knob shown in FIG. 20.

### DETAILED DESCRIPTION

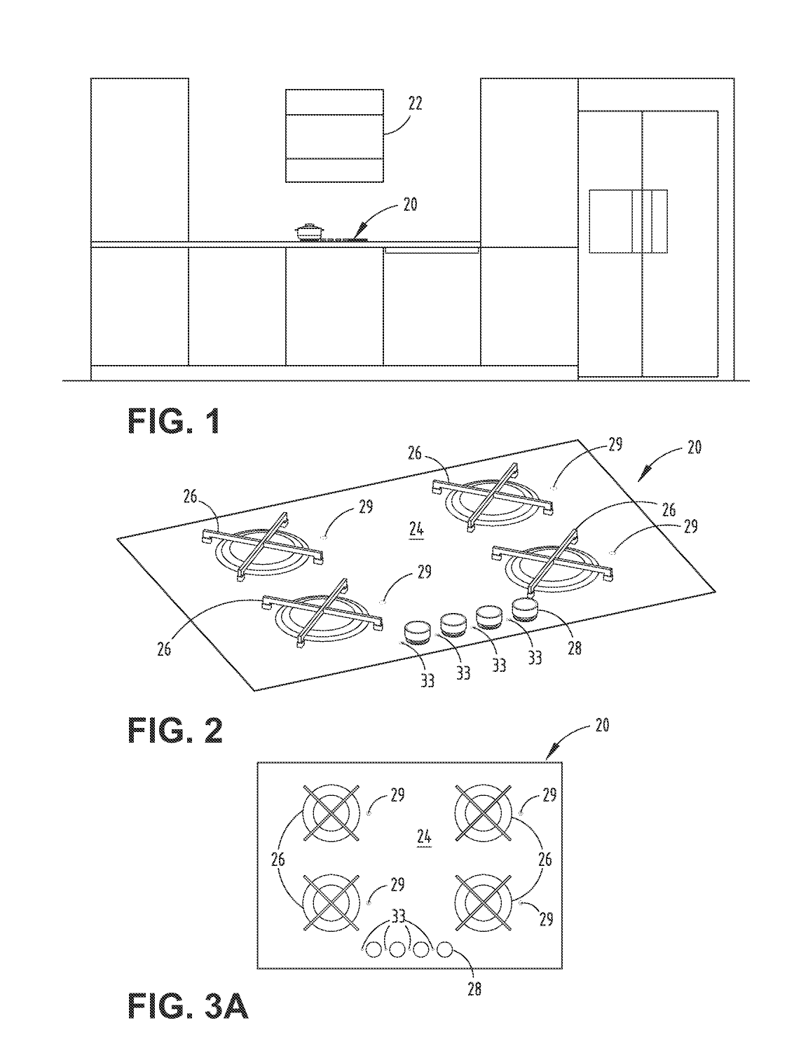

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations except for expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

FIG. 1 provided herein illustrates the environment of a cooktop 20 and a hood 22 as described herein. The cooktop 20 may be a free-standing range or countertop installation, and may be a gas cooktop, a glass-on-glass cooktop, an electric coil cooktop, a smooth electric cooktop, an induction cooktop, or any other type of cooktop. The devices and the methods described herein are intended to direct the user to the proper burner and corresponding control and to make it easier for a user to use the cooktop.

A first aspect, as illustrated in FIGS. 2-5, includes the cooktop 20 having a cooktop surface 24 and at least one burner 26. Each burner 26 has a corresponding control knob 28, which controls the ignition and intensity of heat applied to the burner 26. A burner sensor 29 is associated with each burner 26. The burner sensor 29 detects the presence of a pot 30 (or other object to be heated) on the burner 26.

The burner sensor 29 used to detect the pot 30 on the burner 26 may be one of a number of types of sensors, including, but not limited to, an optical sensor, a proximity sensor, a weight sensor, a magnetic sensor, a conductive sensor, an infrared sensor, an inductive sensor or a piezoelectric sensor. Additionally, the single burner sensor 29 may be capable of sensing the presence of the pot 30 on any one of a number of burners 26, or there may be individual burner sensors 29, with one associated with each burner 26, so long as the burner sensor 29 is able to distinguish on which burner 26 the pot 30 has been placed.

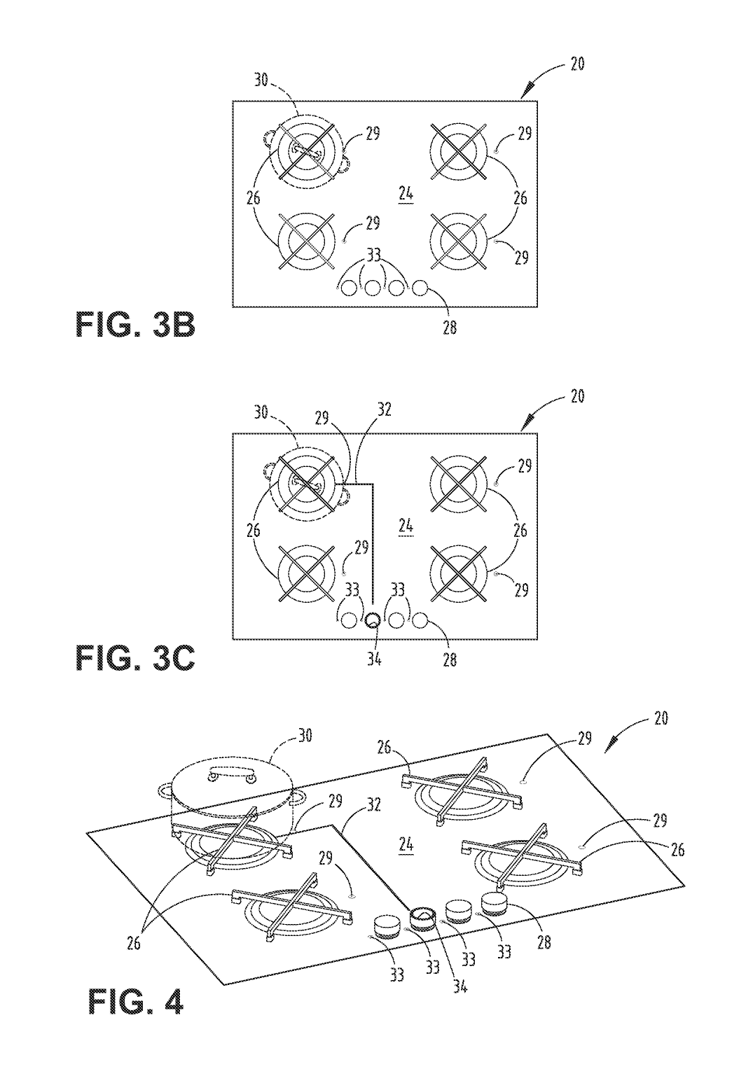

As best illustrated in FIGS. 3C and 4, when the pot 30 is placed on one of the burners 26, the burner sensor 29 detects the presence of the pot 30, and sends a message to a controller, which causes an illuminated path 32 to be lighted, extending from the burner 26 with the pot 30 placed thereon to the corresponding control knob 28 for that burner 26.

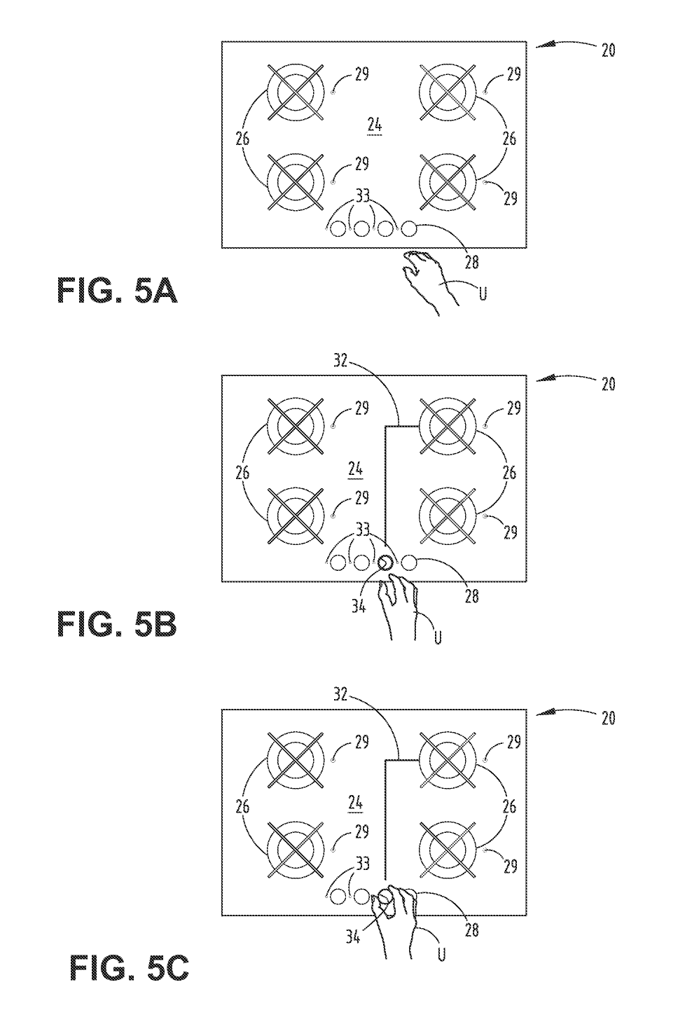

Further, in the first embodiment as described herein, as best illustrated in FIGS. 5A-5C, a control knob sensor 33 may be associated with each control knob 28. The control knob sensor 33 detects the proximity or touch of a user U to the control knob 28. When a user U is detected in close proximity or is touching a control knob 28, the control knob sensor 33 sends a message to the controller, which causes the illuminated path 32 to be lighted, extending from the relevant control knob 28 that the user U has approached or touched.

The control knob sensor 33 that is used to detect the proximity or contact of the user U with the control knob 28 may be one of a number of types of sensors, including, but not limited to, an optical sensor, a proximity sensor, an infrared sensor, or a sensor to detect a force applied to the control knob 28, such as a capacitive recognition sensor. Additionally, there may be a single control knob sensor 33 which is capable of sensing the presence of the user U adjacent to or touching any one of a number of the control knobs 28, or there may be individual control knob sensors 33, with one control knob sensor 33 associated with each control knob 28, so long as the control knob sensor 33 is able to distinguish which control knob 28 the user U has approached or touched.

The illuminated path 32 may include a solid light path or may include an intermittent line of lights. The illuminated path 32 may include a single intensity (brightness/lumens) of lights, or the intensity may be varied along the length of the illuminated path 32. The illuminated path 32 may include a dotted or dashed line of lights, and the lights may vary in intensity or flash over time. The illuminated path 32 may use LED lights or an electroluminescent wire, a light guide to project illumination along a path, or a printed light circuit, having a configuration to permit illumination along the length of the illuminated path 32. These lighting elements may be located on top of the cooktop surface 24, embedded in the cooktop surface 24, or below the cooktop surface 24 if the cooktop surface 24 is at least partially translucent or transparent to the illumination. Incandescent lighting may also be used.

The illuminated path 32 serves to link each burner 26 with the dedicated control knob 28 of each burner 26 making it easier for the user U to determine the proper burner 26 or the proper control knob 28.

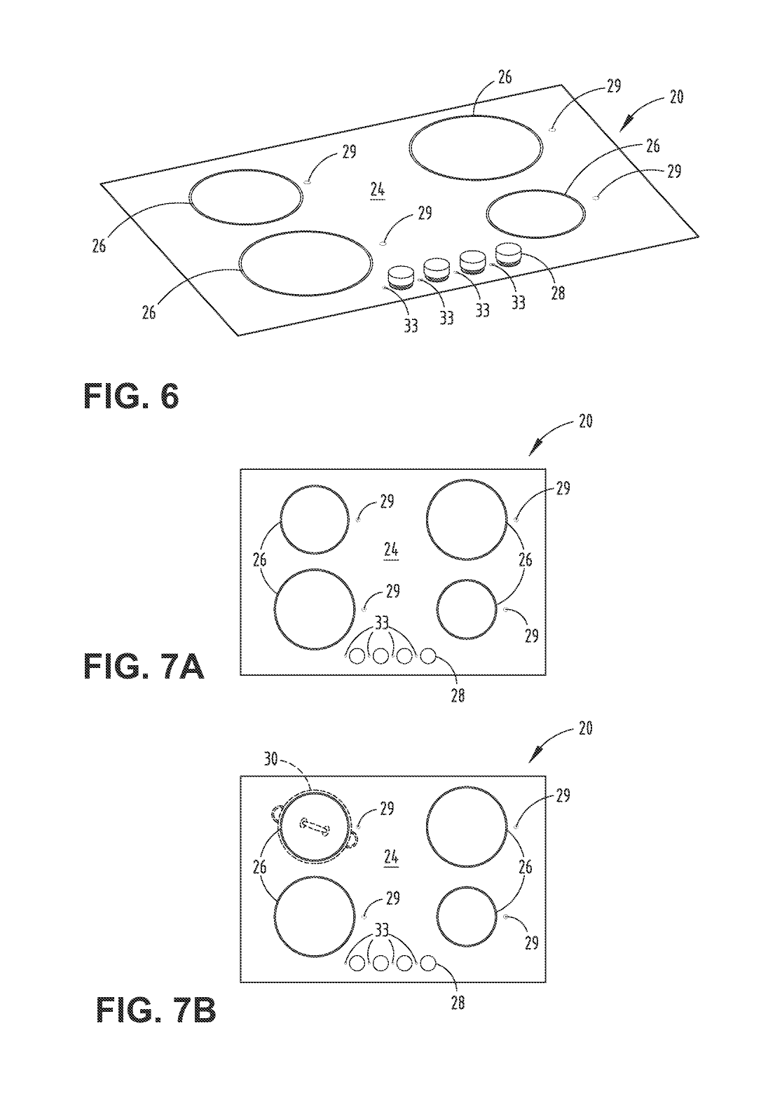

As shown in FIGS. 6-9C, the illuminated signal used to assist the user U in linking the burner 26 with an associated control knob 28 may include an illuminated control knob indicator signal 34 and an illuminated burner indicator signal 36. In one aspect, the illuminated indicator signals 34, 36 are used in combination with the illuminated path 32 described above.

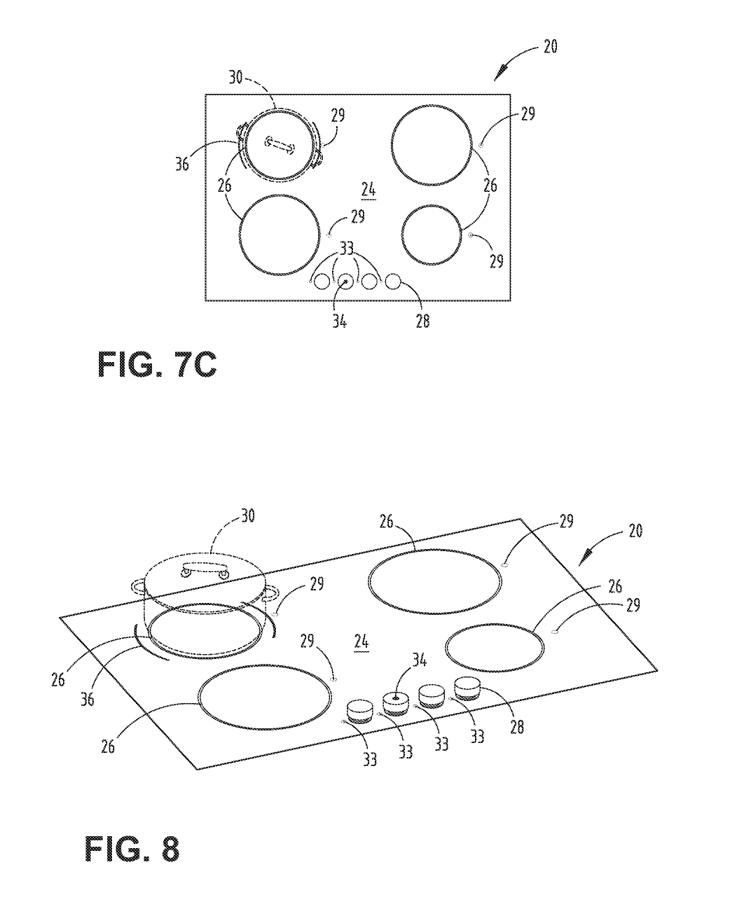

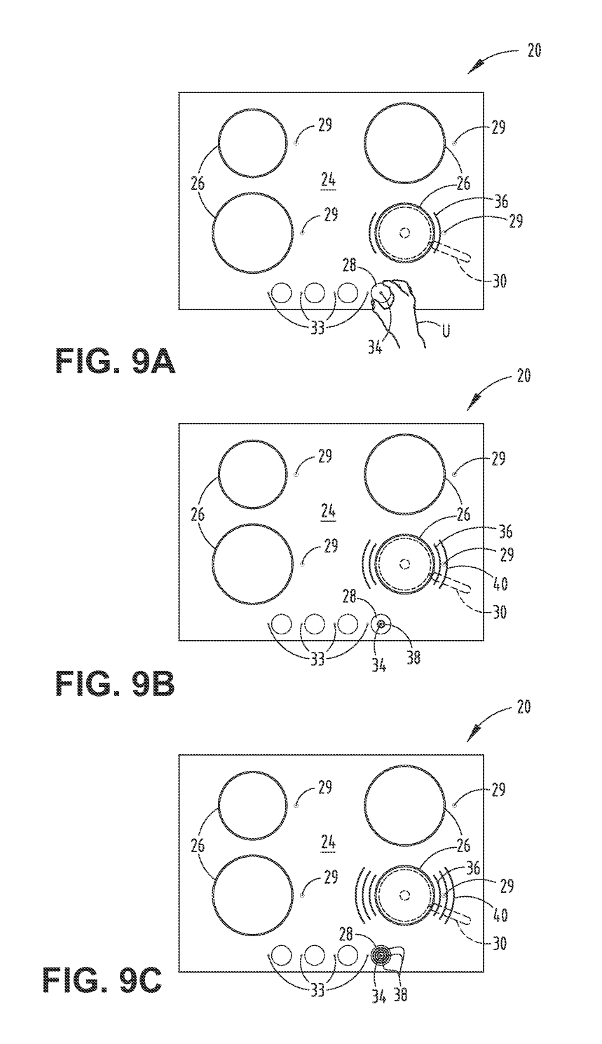

As noted above, the burner sensor 29 is provided to sense when the pot 30 has been placed on the burner 26. As best shown in FIGS. 7C and 8, when the pot 30 is placed on the burner 26, the illuminated burner indicator signal 36 is lit on or near the relevant burner 26 and the illuminated control knob indicator signal 34 is lit on or near the associated control knob 28. Further, as best shown in FIG. 9B, the control knob sensor 33 is provided, such that when the user U approaches or touches the control knob 28, the illuminated control knob indicator signal 34 for the control knob 28 and the burner indicator signal 36 for the associated burner 26 are activated.

With reference again to FIGS. 6-9C, the illuminated burner indicator signal 36 may include a light on the burner 26, a ring of light provided around the circumference of the burner 26, a series of lights around the circumference of the burner 26, or other lighting arrangements that serve to indicate which control knobs 28 are associated with which burners 26. Similarly, the illuminated control knob indicator signal 34 may include a light on the control knob 28, a ring of light provided around the circumference of the control knob 28, a series of lights around the circumference of the control knob 28, or other lighting, which is clearly associated with a particular control knob 28. Light-emitting diode (LED) lighting, optical fiber lighting with light guides, or electroluminescent wire lighting, as well as incandescent lighting devices, as desired. The illuminated control knob indicator signal 34 may include a variety of configurations, as described below.

Additionally, to provide feedback to the user about the heat intensity of the setting of the burner 26, the control knob 28 may be equipped with a control knob heat intensity signal 38, the burner 26 may be equipped with a burner heat intensity signal 40, or both the control knob 28 and the burner 26 may be equipped with heat intensity signals 38, 40. The control knob heat intensity signal 38 may be lit using the same lighting mechanism as described in reference to the illuminated control knob indicator signal 34.

As shown in FIGS. 9B and 9C, the control knob heat intensity signal 38 may include rings of light around the control knob 28, with a greater number of rings indicating a higher intensity of heat. The burner heat intensity signal 40 may also include a ring or rings of light. Alternatively, a light signal may be provided where the intensity (brightness/lumens) of light may be increased to show an increased heat setting for either the control knob heat intensity signal 38 or the burner heat intensity signal 40. Light signals that change in intensity may be integrated with or include the same aspects of the illuminated control knob indicator signal 34 or the illuminated burner indicator signal 36.

The heat intensity signals 38, 40, as described herein, may be particularly helpful to indicate the heat setting of the burner 26 on the type of cooktop 20 where the level of heat is not readily visible, such as electric cooktops. However, the use of heat intensity signals 38, 40 is not limited to such cooktops 20.

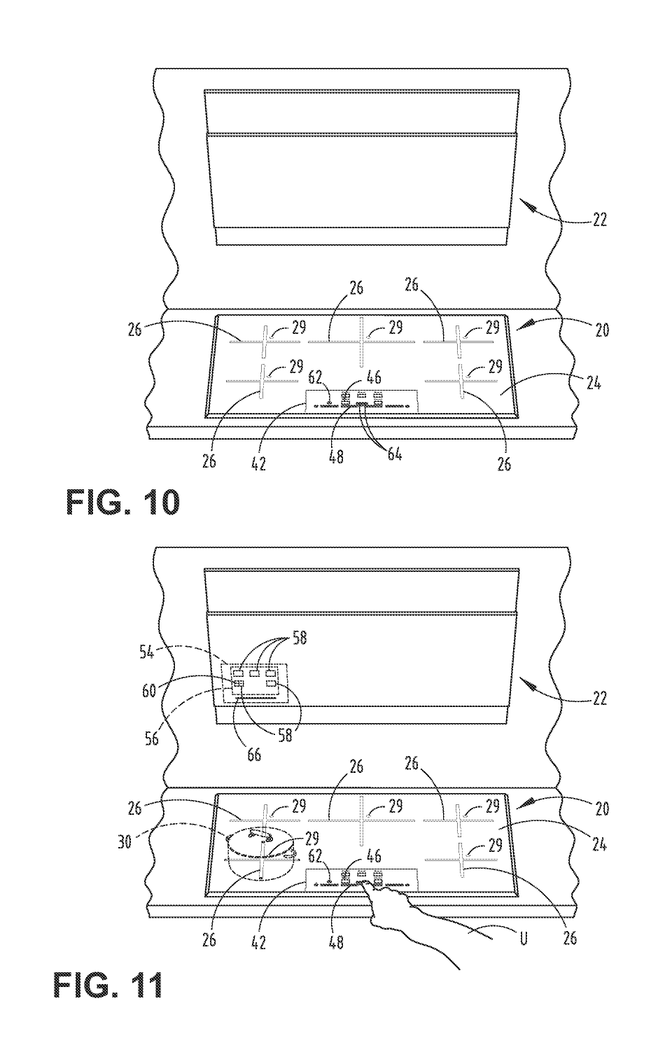

Referring now to the embodiments of FIGS. 10-12E, the cooktop 20 and the hood 22 are shown with the cooktop 20 having burner sensors 29, as described in relation to the previous embodiments, and also includes a burner map 42 to set the controls of the burner 26. The burner map 42 includes burner selector buttons 44 to correspond with each burner 26 of the cooktop 20, with each burner selector button 44 being associated with a particular burner 26, and with each of the burner selector buttons 44 being a mechanical button, a capacitive button, or other button that can be selected by the user U. Each burner selector button 44 further comprises a status display 46 for the associated burner 26. The burner map 42 further comprises a control bar 48 or other controller. When the pot 30 is placed on the burner 26, the burner sensor 29 detects the presence of the pot 30, and a burner status indicator signal 50 is activated in the corresponding burner selector button 44. The cooktop 20 communicates with the hood 22 via a communication link, which may be wired or wireless. The communication link may be, for example, radio frequency, infrared, Wi-Fi, Bluetooth, audio, projection, or optical.

The hood 22 includes a hood display 54 having a hood burner map 56. Located on the hood burner map 56 are hood status display boxes 58 corresponding to each of the burners 26 on the cooktop 20. Each hood status display box 58 further includes a hood burner status indicator signal 60.

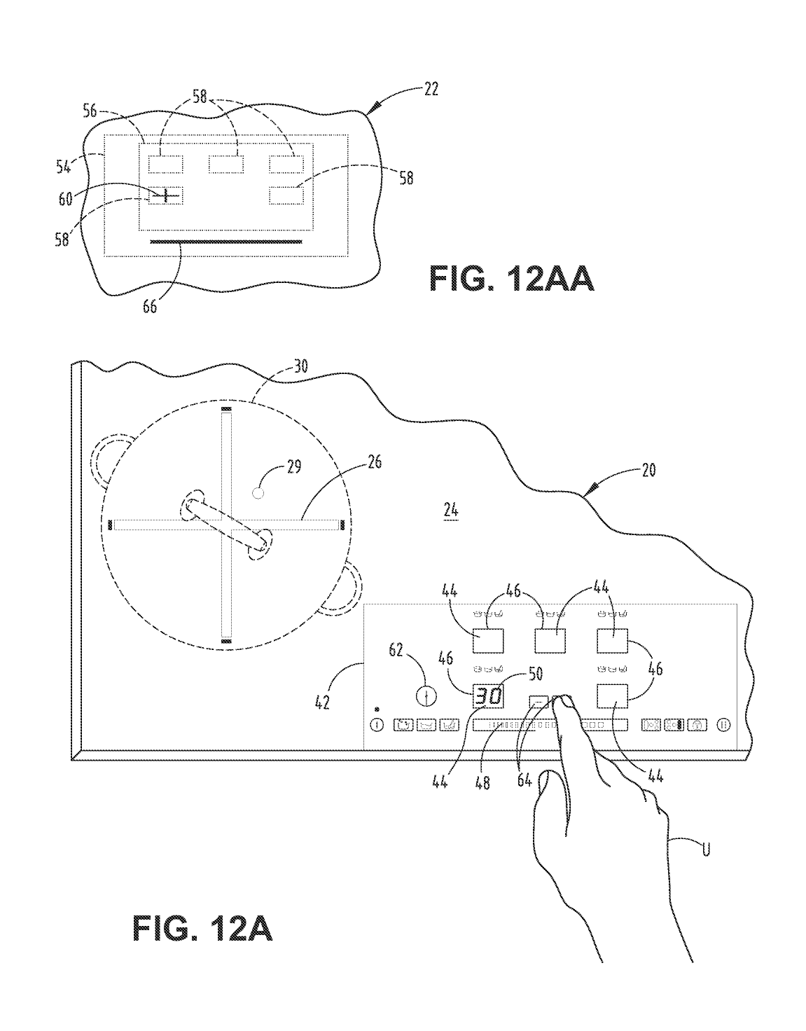

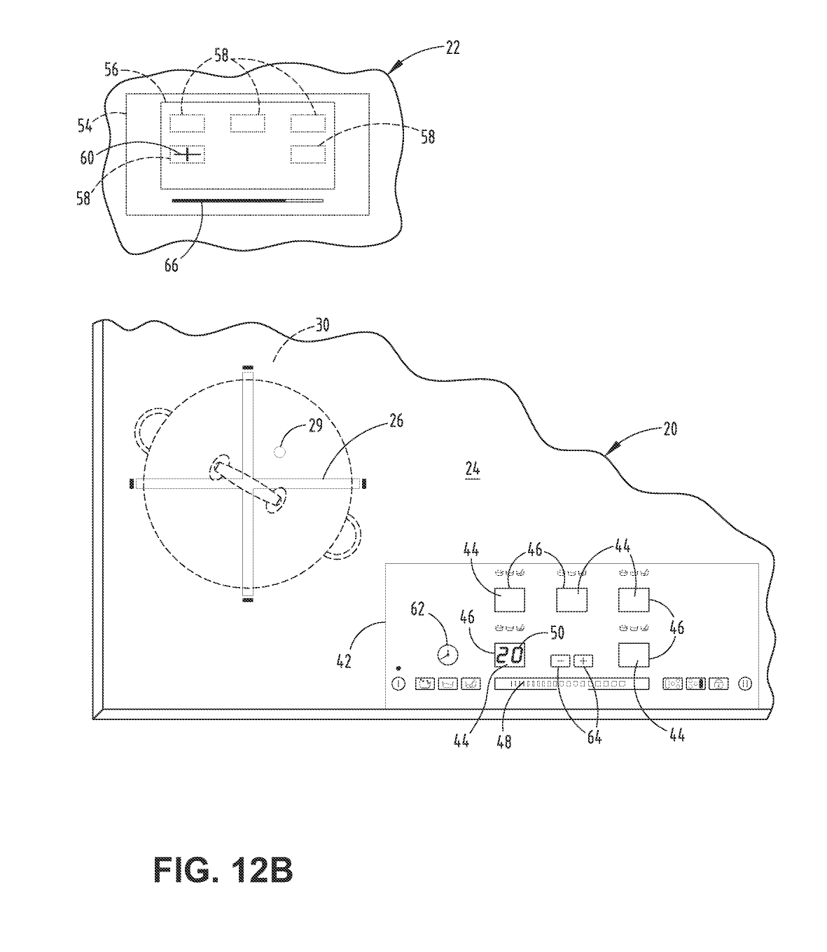

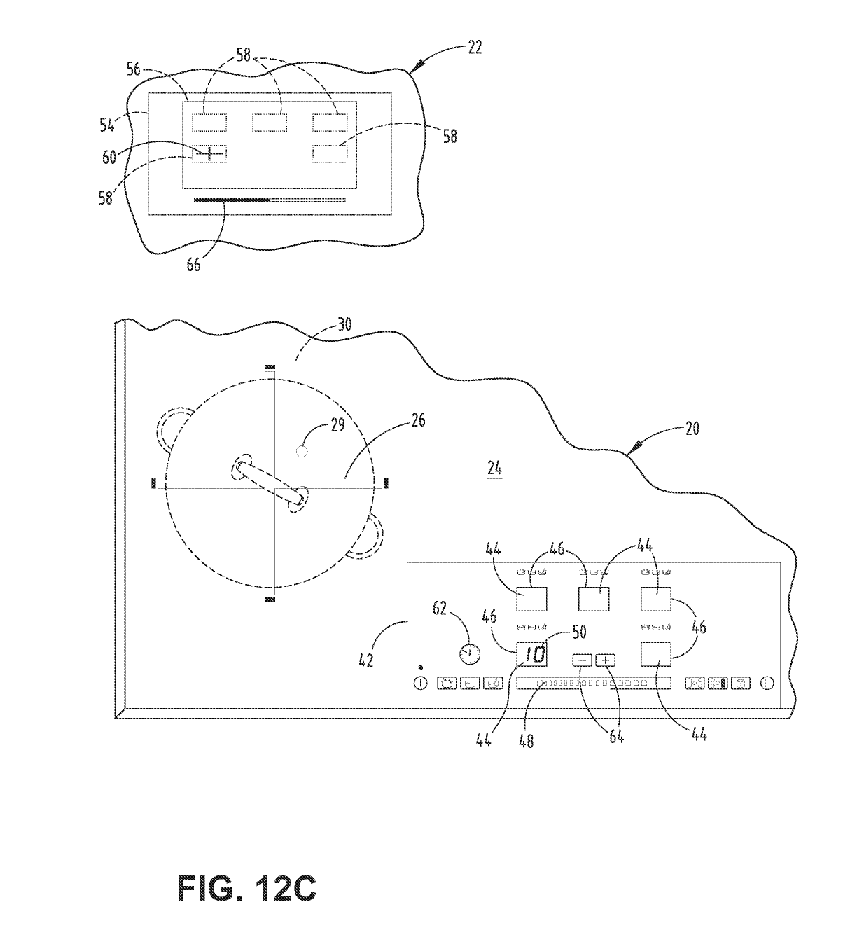

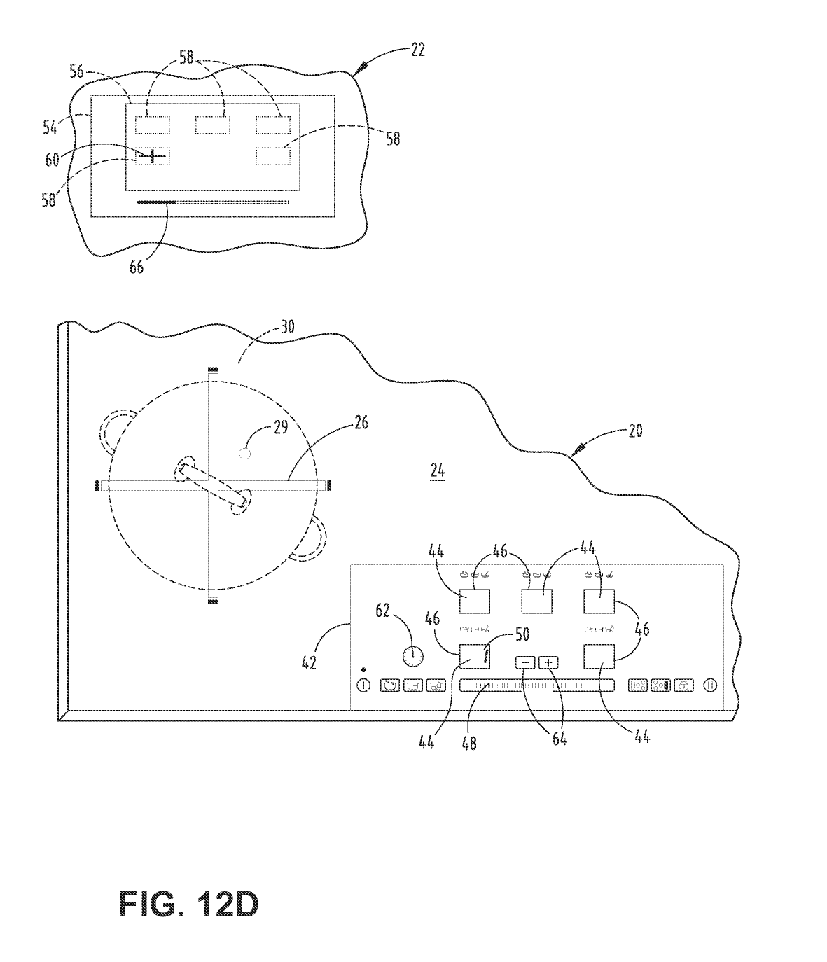

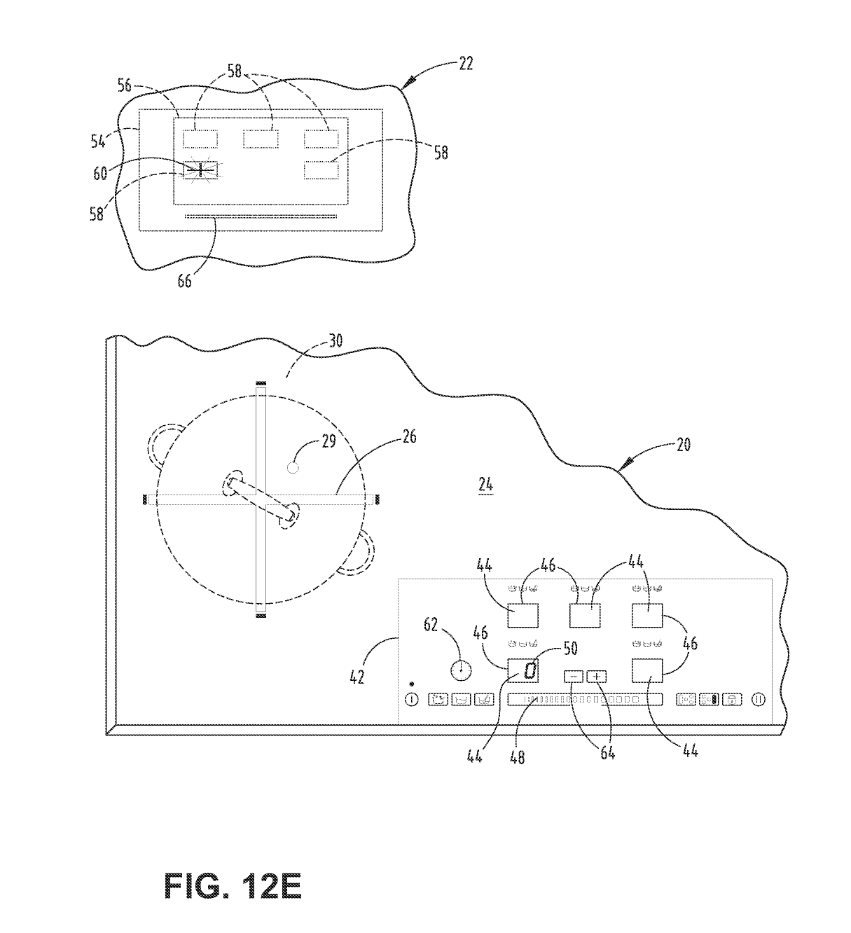

The hood burner status indicator signal 60 may be activated to indicate when the pot 30 is placed on the burner 26 on the cooktop 20, or may indicate when the burner 26 is turned on by the user U, or both. In one embodiment, the user U can select the timer control by selecting a timer button 62 and setting the timer using set buttons 64. The hood display 54 includes a hood timer status indicator 66, as shown in FIGS. 11-12E, that provides the user U with a visual representation showing the amount of time left on the timer. When the timer expires, the hood burner status indicator signal 60 may blink, flash a different color light, turn a different color, or otherwise indicate to the user U that the timer for the applicable burner 26 has expired.

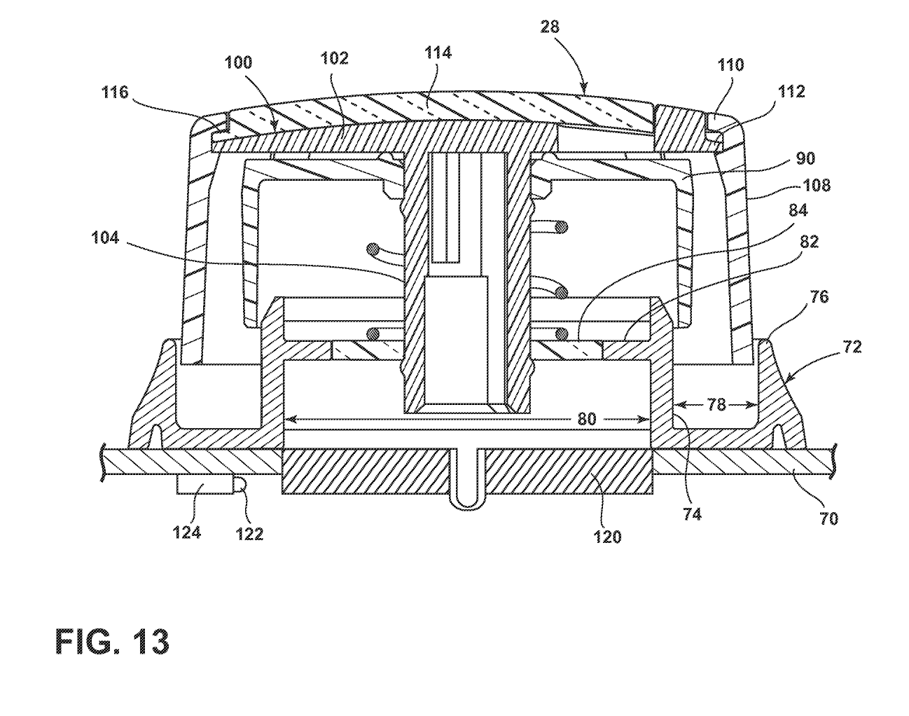

Potential constructions useful for illuminating the control knob 28 to provide the illuminated control knob indicator signal 34 or the control knob heat intensity signal 38 are illustrated in FIGS. 13-21. The knob disclosure provided herein allows the surface of the control knob 28 to be lit in an even manner, and allows lighting to be projected around the base of the control knob 28, if desired.

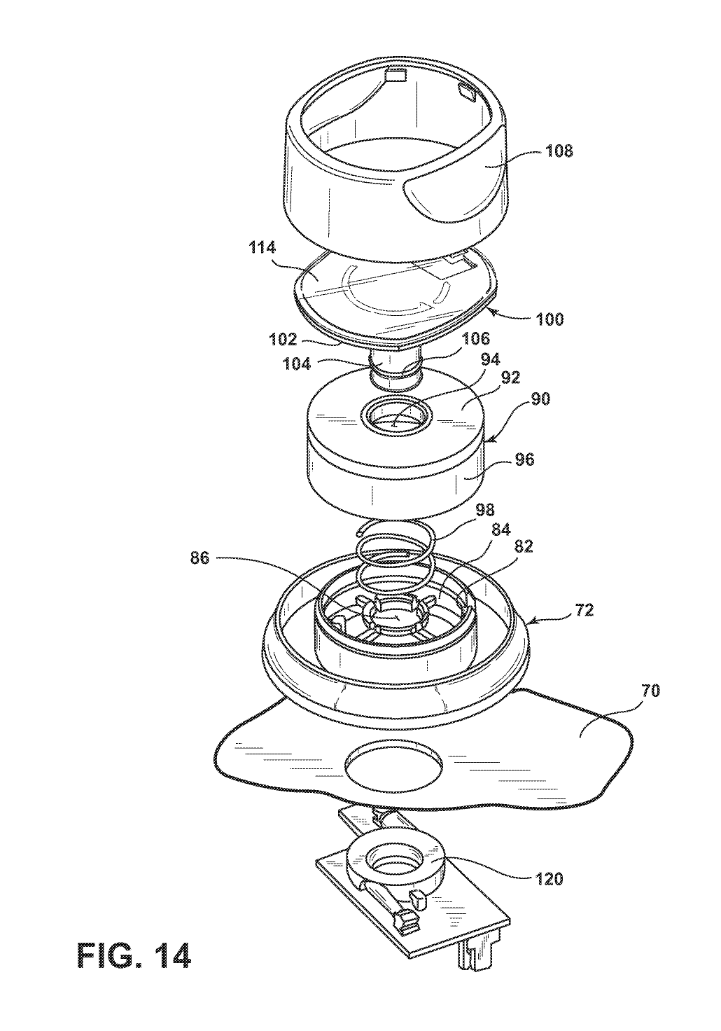

As shown in FIGS. 13 and 14, in one embodiment, the control knob 28 is mounted on an oven console 70. The control knob 28 includes a skirt 72 with in inner ring 74 and an outer ring 76, forming a channel 78 therebetween, with a central opening 80 located inside the inner ring 74. Retaining features 82 are directed inwardly from the inner ring 74 of the skirt 72. A transparent disk 84 having a central opening 86 is provided within the inner ring 74 of the skirt 72, and the retaining features 82 of the skirt 72 engage with the transparent disk 84 to hold the transparent disk 84 in place. Alternatively, the skirt 72 and the transparent disk 84 may be integrally formed using materials of varying transparency or may be fastened together using other known methods, such as adhesives or other fasteners. Together, the skirt 72 and the disk 84 form the side of the control knob 28, which faces the oven console 70.

A skirt cover 90, having a disk shaped top 92 with a central opening 94 therethrough and a circumferential wall 96 extending therefrom, is located above the skirt 72. A spring 98 is placed between the transparent disk 84 and the skirt cover 90, to urge the skirt cover 90 upward, away from the transparent disk 84. The skirt cover 90 is partially or completely transparent to light. The portion of the skirt cover 90 which is partially or completely transparent to light is also preferably capable of diffusing light, so that light which enters the control knob 28 through the transparent disk 84 is evenly distributed by the skirt cover 90. The skirt cover 90 may also have graphics or designs printed thereon.

A knob shaft body 100, having a broad top portion 102 and a stem 104 is provided. The stem 104 of the knob shaft body 100 extends through the central openings 94, 86, 80 of the knob skirt cover 90, the transparent disk 84, and the skirt 72, respectively, and engages, directly or indirectly with the gas control valve or electrical control features of the knob 28. The stem 104 may include a mechanically engaging feature, such as a raised ring 106, to engage with the central opening 86 of the transparent disk 84, and to thereby hold the elements of the control knob 28 together. The broad top portion 102 of the knob shaft body 100 may have cutouts therein, or have portions which are partially or completely transparent to light, so that light reaches and is preferably diffused by the skirt cover 90 is viewable through the broad top portion 102 of the knob shaft body 100.

A shell 108 is provided that extends circumferentially around the periphery of the knob shaft body 100, and extends downward into the channel 78 formed in the skirt 72. The knob shaft body 100 and the shell 108 are provided with engaging features 110, 112, so that the shell 108 is snap-fit over the knob shaft body 100.

Additionally, a cover 114 may optionally be provided over the broad top portion 102 of the knob shaft body 100, with the cover 114 also having engaging features 116 to engage with the shell 108. The cover 114 may be wholly or partially transparent to light.

Below the oven console 70, a console light guide 120 is provided, with a light source 122 and a power supply 124 to power the light source 122. The console light guide 120 directs the transmission of light upwards, through an opening in the oven console 70, to the transparent disk 84. The transparent disk 84 allows the light to enter the control knob 28, and transmits the light into the skirt cover 90. The light is diffused by the skirt cover 90, and transmitted to the broad top portion 102 of the knob shaft body 100, where it can be transmitted through transparent or translucent sections thereof, or openings therein. The cover 114, which is wholly or partially transparent to light, allows the light which has been reflected into the broad top portion 102 of the knob shaft body 100 to be viewed by the user U. Such light will be transmitted more strongly (to allow brighter light) in the areas of the cover 114 that have a greater transparency to the light.

The control knob 28 having the construction depicted in FIGS. 13 and 14 can be lighted to provide direction to the user U, and is also removable by the user U for cleaning or other maintenance of the surface of the oven console 70. As described above, once assembled, the control knob 28 can be removed in a single piece by the user U, such that no electrical connections, wiring, or lighting elements are exposed.

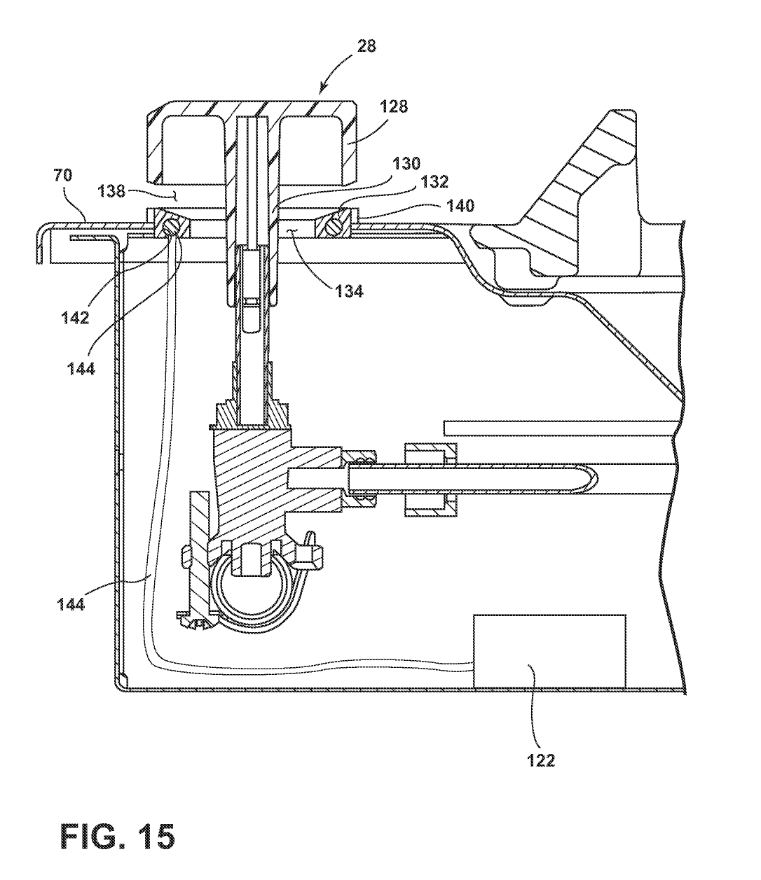

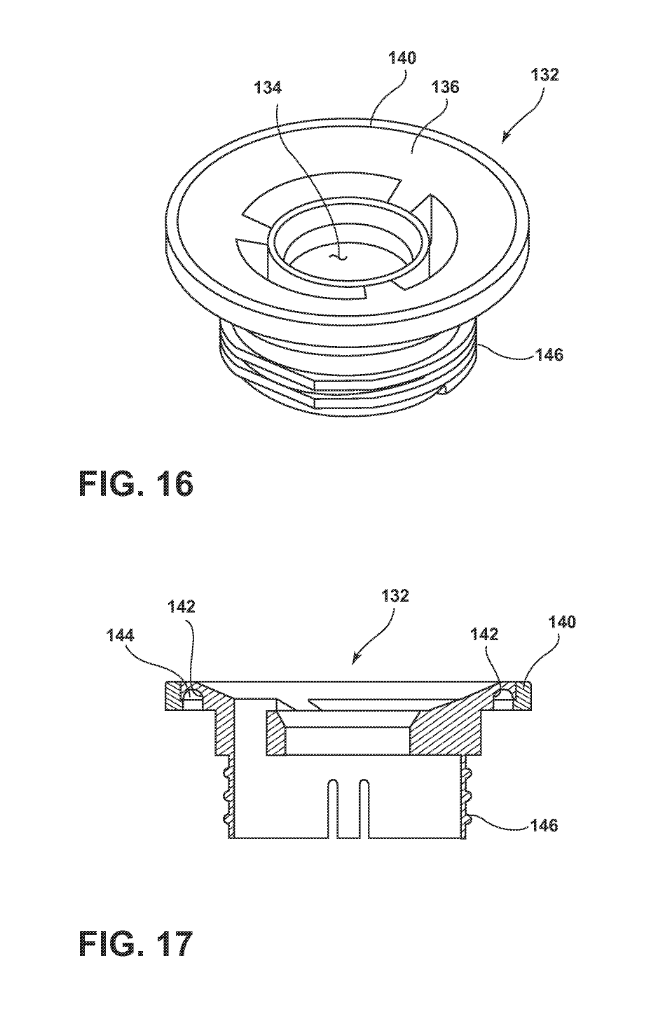

As shown in FIG. 15, the lighted control knob 28 may optionally be provided with lighting around the base of the control knob 28. As shown in FIG. 15, the control knob 28 includes a knob body 128, which is adjusted by the user U and a stem 130, which operatively connects the control knob 28 to the workings of the stove controlled by the control knob 28. In the embodiment shown in FIGS. 15 and 16, a light guide housing 132 having a central bore 134 therethrough and a flange portion 136 extending outwardly from the central bore 134 is attached to the oven console 70 at the base of the control knob 28. The stem 130 passes through the central bore 134, and the knob body 128 is provided above the oven console 70 and the light guide housing 132. There is desirably a space 138 between the light guide housing 132 and the knob body 128, allowing transmission of light that is visible to the user U.

An optional decorative jacket 140 may be provided circumferentially around the outer edge of the light guide housing 132 to improve the appearance of the light guide housing 132. The decorative jacket 140 may be attached using any known means, including, without limitation, adhesive, friction-fitting, or mechanical engagement, or may be applied in an overmolding process.

As shown in FIGS. 15 and 17, a pocket 142 is arranged circumferentially around the flange portion 136 of the light guide housing 132, permitting placement of an optical fiber 144 within the pocket 142, such that the light emitted from the optical fiber 144 is distributed within and throughout the light guide housing 132, causing an even glow of the light guide housing 132. The optical fiber 144 used is desirably of the side-emitting type, and may be braided or jacketed. The use of side-emitting fiber reduces the lighting lost to areas not visible to the user U. Certain side-emitting optical fibers 144 include a plurality of fiber optics with a given refractive index, and a cladding material with a second refractive index, allowing the side-emitting property of the optical fibers 144. The change in index of refraction, going from the fiber optics to the cladding material, permits light traversing the optical fiber 144 to more efficiently be diverted out of the optical fiber 144 through the side of the optical fiber 144. Therefore, light is directed upwardly and or outwardly from the oven console 70, as desired, and is visible to the user in the space 138 between the knob body 128 and the light guide housing 132. The use of reflective coatings, textured diffractive surfaces, or both may be used to enhance the appearance of the lighting that is emitted from the light guide housing 132, though with the use of the optical fiber 144, the light emitted from the light guide housing 132 would generally be more evenly distributed than the light emitted from LEDs directed toward the light guide housing 132.

The use of the side-emitting optical fiber 144, as shown in FIG. 15, permits placement of the light source 122 away from the hot region of the stove, with the optical fiber 144 optically connecting the light source 122 to the desired viewing region for the light. Separation of the light source 122 from the heated elements of the stove lengthens the operable life of the light source 122. The optical fiber 144 may also be jacketed or otherwise protected from the heat source, further protecting the lighting mechanism.

The light guide housing 132, as shown in FIGS. 16 and 17, includes the flange portion 136 and an optional threaded portion 146. The flange portion 136 permits placement of the optical fiber 144, as described above, while the threaded portion 146 facilitates installation in an opening of the oven console 70. The light guide housing 132 described herein may also be used as the console light guide 120 with the control knob 28 having the knob shaft body 100, if desired.

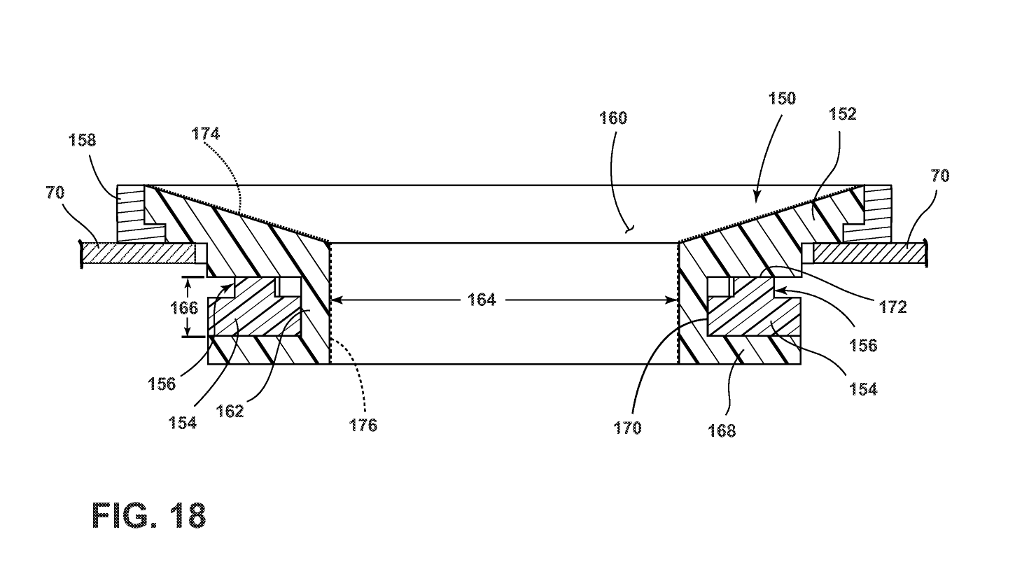

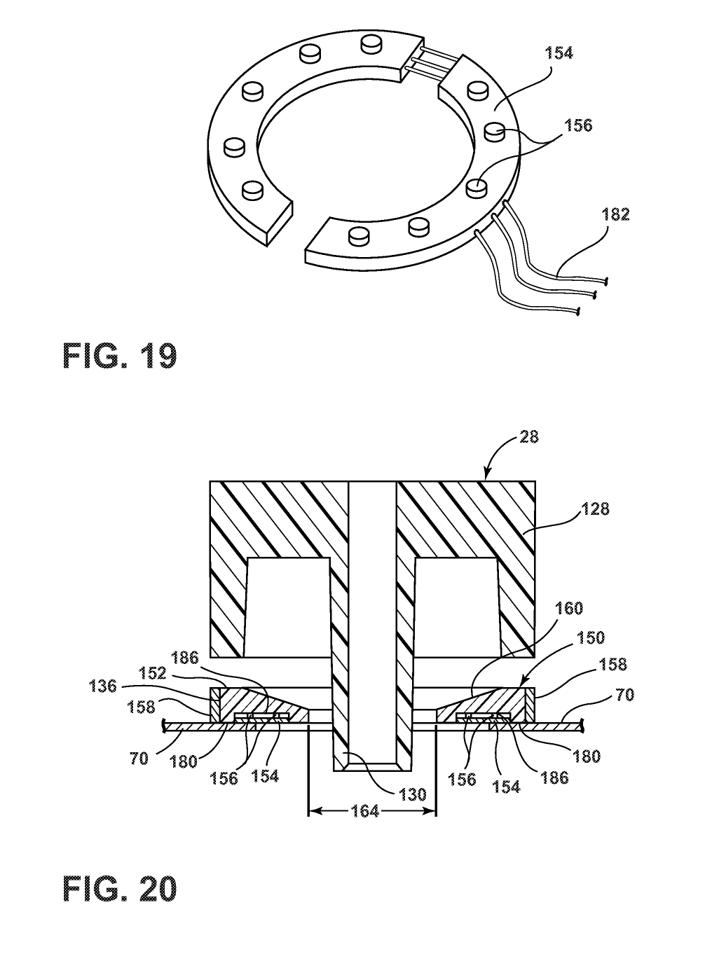

FIGS. 18 and 19 depict an additional embodiment of a light guide assembly 150 illuminated directly by LED lights 156, rather than the optical fiber 144, which could be used with the control knobs 28, as shown in FIG. 13 or 15. In the embodiment depicted in FIGS. 18 and 19, the light guide assembly 150 includes a light guide 152, a printed circuit board 154 with the LED lights 156, and an optional decorative trim piece 158. The light guide 152 has a top diffuser surface 160 oriented generally upward toward the control knob 28 upon installation, a light guide stem portion 162 with a central opening 164 therethrough, and an LED notch 166 around the circumference thereof. The LED notch 166 is defined by a bottom flange 168, an inner wall 170, and a top transmission wall 172. The LED notch 166 is located with at least a portion thereof radially inward from the edge of the opening in the oven console 70, such that there is not a metal layer between the top transmission wall 172 and the top diffuser surface 160. The printed circuit board 154 containing the LED lights 156 is positioned within the LED notch 166, such that the light emitted by the LED lights 156 is directed upward through the transmission wall 172 and to the top diffuser surface 160.

Referring again to FIG. 19, the printed circuit board 154 may be manufactured in two pieces connected by a harness 182, and fastened around the circumference of the light guide 152. To attach the printed circuit board 154 to the light guide 152, the printed circuit board 154 may be placed in a mold with the light guide 152, and a plastic injected around the printed circuit board 154, so that it will be permanently attached to the light guide 152. Alternatively, the printed circuit board 154 could be adhered, soldered, or mechanically affixed to the light guide 152.

The decorative trim piece 158 (FIG. 20) may optionally be affixed around the circumference of the light guide 152, which will be located above the oven console 70 when installed. The decorative trim piece 158 may be affixed to the light guide 152 by any known process, including, without limitation, overmolding, adhering, and mechanical engagement.

To improve the light diffusion characteristics of the light guide assembly 150, the top diffuser surface 160 may be texturized or may be coated with a diffuser coating 174, such as a thin layer of plastic, to eliminate “hot spots” or brighter areas. Additionally, a reflective coating 176 may be used on certain surfaces of the light guide 152 to reflect the light emitted from the LED lights 156 to the diffuser top surface 160, such as around the interior of the central opening 164, so that less light is lost through the central opening 164 where it cannot be viewed by the user when the control knob 28 is in place.

The light guide assembly 150 may be glued or otherwise adhered or affixed to the oven console 70, and the control knob 28 is installed through the central opening 164 in the light guide 152.

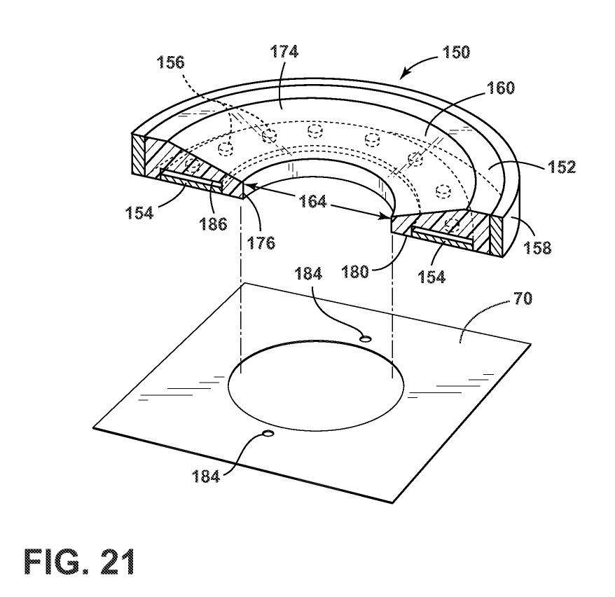

An additional embodiment of the lighted knob 28 is depicted in FIGS. 20 and 21, also including the knob 28 having the knob body 128 and the stem 130. Like components in this embodiment are given the same reference numbers as used in previously described embodiments. An above-console light guide assembly 150 is shown, which includes the light guide 152, the printed circuit board 154 with the LED lights 156, and the decorative trim piece 158. The light guide 152 in the embodiment shown in FIGS. 20 and 21 includes the flange portion 136 with the top diffuser surface 160, a bottom surface 180 generally opposed to the top diffuser surface 160, and the central opening 164. The light guide 152 in the light guide assembly 150 is located primarily above the oven console 70. Where a wiring harness 182 is used to light the LED lights 156, one or more additional holes 184 may be provided through the oven console 70 to allow the wiring harness 182 to pass through the oven console 70.

The printed circuit board 154 is in the shape of a ring, with LED lights 156 thereon. The printed circuit board 154 is positioned in an indentation 186 around the bottom surface 180 of the light guide 152, with the LED lights 156 directed upwards toward the top diffuser surface 160. The printed circuit board 154 and the LED lights 156 may be attached to the light guide 152 using conventional adhesive or mechanical engagement features, or may be attached using overmolding, second stage molding, or potting. Additionally, the optional decorative trim piece 158 is provided around the outer circumference of the light guide 152.

As described above, the diffuser coatings 174 and the reflective coatings 176 may be used on the light guide 152 to enhance the proportion of light that is visible around the top of the light guide 152, and to enhance the appearance of the light and minimize the appearance of “hot spots” from the LED lights 156.

The assembled light guide assembly 150 is affixed to the top surface of the oven console 70, using known methods including, without limitation, adhesives or mechanical engagement features. The stem 130 can be inserted through the central opening 164 of the light guide assembly 150 and the opening in the oven console 70 to operatively connect with control elements of the cooktop 20.

It is understood that the optical fiber 144 or individual LED lights 156 could be used with each of the types of light guides described herein with minor changes to allow the fitting of the parts, and that all combinations of the features described herein could be used together or separately to enhance the appearance and efficiency of the lighting.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structures and methods without departing from the concepts of the present invention, and further it is to be understood that such concepts are intended to be covered by the following claims unless these claims by their language expressly state otherwise.

The above description is considered that of the illustrated embodiments only. Modifications of the invention will occur to those skilled in the art and to those who make or use the invention. Therefore, it is understood that the embodiments shown in the drawings and described above is merely for illustrative purposes and not intended to limit the scope of the invention, which is defined by the following claims as interpreted according to the principles of patent law, including the Doctrine of Equivalents.

What is claimed is:

1. A cooktop, comprising:
a first burner;
a pot detection sensor functionally coupled to the first burner to detect the presence of a pot on the first burner;
a first controller functionally coupled to the first burner;
a path, with a first end thereof terminating adjacent the first burner and a second end thereof terminating adjacent the first controller; and
a lighting element, wherein the lighting element illuminates the path when the pot detection sensor senses the presence of the pot on the first burner.

2. The cooktop of claim 1, further comprising:
a second burner;
a second pot detection sensor functionally coupled to the second burner to detect the presence of the pot on the second burner;
a second controller functionally coupled to the second burner;
a second path, with a first end thereof terminating adjacent the second burner and a second end thereof terminating adjacent the second controller; and
a second lighting element which illuminates the second path when the second pot detection sensor senses the presence of the pot on the second burner.

3. The cooktop of claim 2, wherein a single pot detection sensor is functionally connected to the first burner and to the second burner to detect the presence of the pot on either of the first burner or the second burner.

4. The cooktop of claim 1, wherein the pot detection sensor is one of an optical sensor and a weight sensor.

5. The cooktop of claim 1, further comprising:
a hand detection sensor functionally coupled to the first controller to detect the presence of a hand approaching the first controller, wherein the lighting element illuminates the path when the hand detection sensor senses the presence of a hand approaching the first controller.

6. The cooktop of claim 1, further comprising:
a control knob indicator signal, a burner indicator signal, or both.

7. The cooktop of claim 6, wherein the control knob indicator signal is visible on the surface of the controller, and wherein the controller is a control knob that can be removed from the cooktop without exposing electrical wiring.

8. The cooktop of claim 6, wherein the control knob indicator signal includes a light emitted by a light guide, and wherein the light guide includes a top diffuser surface lit by a side-emitting optical fiber.

9. A cooktop, comprising:
a first burner;
a first controller functionally coupled to the first burner;
a hand detection sensor functionally coupled to the first controller to detect the presence of a hand approaching the first controller;
a path with a first end thereof terminating adjacent the first burner and a second end thereof terminating adjacent the first controller; and
a lighting element which illuminates the path when the hand detection sensor senses the presence of a hand approaching the first controller.

10. The cooktop of claim 9, further comprising:
a second burner;
a second controller functionally coupled to the second burner;
a hand detection sensor functionally coupled to the second controller to detect the presence of a hand approaching the second controller;
a second path with a first end thereof terminating adjacent the second burner and a second end thereof terminating adjacent the second controller; and
a second lighting element which illuminates the second path when the second hand detection sensor senses the presence of the hand approaching the second controller.

11. The cooktop of claim 10, wherein a single hand detection sensor is functionally connected to the first controller and to the second controller to detect the presence of the hand approaching either of the first burner or the second burner.

12. The cooktop of claim 9, wherein the hand detection sensor is an optical sensor.

13. A cooktop indicator system, comprising:
a controller functionally coupled to a first burner, wherein the first burner has at least a first heat setting and a second heat setting, and wherein the controller is used to select the desired heat setting; and
at least one indicator light on or around the controller, having at least a first indicator setting associated with the first heat setting and a second indicator setting associated with the second heat setting, and wherein the second indicator setting varies from the first indicator setting in the number of indicator lights that are illuminated, the color of the indicator lights that are illuminated, or the intensity of the indicator lights that are illuminated.

14. The cooktop indicator system of claim 13, wherein the second indicator setting varies from the first indicator setting in the number of indicator lights that are illuminated.

15. The cooktop indicator system of claim 13, wherein the controller is a knob provided on a console, the knob having a front surface, a first indicator light, and a second indicator light, wherein each of the first and second indicator lights is in the shape of a ring on the front surface of the knob, and wherein the second indicator light is placed concentrically outward from the first indicator light.

16. The cooktop indicator system of claim 15, wherein the knob is removable from the console.

17. The cooktop indicator system of claim 13, wherein the second indicator setting varies from the first indicator setting by the intensity of the first and second indicator lights that are illuminated.

18. The cooktop indicator system of claim 13, wherein the controller is a knob protruding from the console, wherein the knob includes a front surface and a peripheral wall extending from the front surface toward the console, wherein the peripheral wall and the console define a space therebetween, and wherein the first and second indicator lights illuminate the space between the peripheral wall and the console.

19. The cooktop indicator system of claim 17, wherein the knob is removable from the console.

20. A cooktop and hood display system, comprising:
a cooktop having a cooktop surface with a first burner, a sensor to detect a cooktop status measurement, and a transmitter; and
a hood having a receiver that directly or indirectly receives cooktop status measurements from the transmitter and including a display that displays the cooktop status measurement.

21. The cooktop and hood display system of claim 20, wherein the cooktop status measurement is one of power, heat intensity, and remaining time on a timer.

22. The cooktop and hood display system of claim 20, wherein the cooktop status measurement is an amount of time remaining on a timer, and wherein a time expiration signal is displayed on the display when there is no time remaining on the timer.
